(19) United States
(12) Patent Application Publication
(10) Pub. No.: US 2018/0205275 A1
(43) Pub. Date: Jul. 19, 2018

(54) SURFACE MOUNT PERMANENT MAGNET ATTACHMENT FOR ELECTRIC MACHINE

(71) Applicant: United Technologies Corporation, Farmington, CT (US)

(72) Inventors: Jagadeesh Tangudu, South Windsor, CT (US); Zaffir A. Chaudhry, South Glastonbury, CT (US)

(21) Appl. No.: 15/869,793

(22) Filed: Jan. 12, 2018

Related U.S. Application Data
(60) Provisional application No. 62/445,787, filed on Jan. 13, 2017.

(51) Int. Cl. H02K 1/27; H02K 1/28

(52) U.S. Cl. CPC H02K 1/278; H02K 1/28

(57) ABSTRACT

A rotor of an electric machine includes a rotor core having a plurality of axially-stacked rotor laminations, and a plurality of permanent magnets. The plurality of permanent magnets are first permanent magnets secured at the core outer circumferential surface of the rotor core and are made of a first permanent magnet material with a first magnetic orientation. The plurality of permanent magnets are secured to the rotor core via a plurality of mechanical interface joints defined by at least one first mechanical interface feature having a permanent magnet channel with a magnet channel surface, located inside the permanent magnet and at least one second mechanical interface feature having a core channel with a core channel surface located inside of the rotor core. At least one complimentary mechanical interface member is inserted in the magnet channel and the core channel, having surfaces complimentary to the magnet channel and the core channel.

### CROSS-REFERENCE TO RELATED APPLICATIONS

This application claims the benefit of Provisional Application No. 62/445,787 filed Jan. 13, 2017, which is incorporated herein by reference in its entirety.

### BACKGROUND

The present disclosure relates to electric machines. More particularly, the present disclosure relates to permanent magnet configurations for rotors of electric machines.

When rotor magnets are placed on an outer surface of a rotor for an electric machine, the rotor magnets are typically secured in place by a metallic on nonmetallic wrap or band, or retaining rings to secure the magnets in place under centrifugal forces acting on the magnets during rotation of the rotor. This increases an airgap between the magnets and a stator of the electric machine, resulting in a larger diameter electric machine, lower power density, and higher operating currents of the electric machine and thus lower electric machine efficiency and higher form factor for space-constrained applications.

### BRIEF SUMMARY

In one embodiment, a rotor of an electric machine includes a rotor core, wherein the rotor core includes a plurality of axially-stacked rotor laminations, and a plurality of permanent magnets. Each of the plurality of permanent magnets has a magnet inner circumferential surface, a magnet outer circumferential surface, and two opposing radial side surfaces. The plurality of permanent magnets are secured at the core outer circumferential surface of the rotor core. The permanent magnets are first permanent magnets made of a first permanent magnet material with a first magnetic orientation. The plurality of permanent magnets are secured to the rotor core via a plurality of mechanical interface joints. The plurality of mechanical interface joints are defined by at least one first mechanical interface feature having a permanent magnet channel with a magnet channel surface, located inside the permanent magnet, with the tangent of the magnet channel surface defined by an angle that is between zero and 90 degrees with respect to the magnet inner circumferential surface, at least one second mechanical interface feature having a core channel with a core channel surface located inside of the rotor core, with the tangent of the core channel surface defined by an angle that is between zero and 90 degrees with respect to the core outer circumferential surface. At least one complimentary mechanical interface member is inserted in the magnet channel and the core channel, having surfaces complimentary to the magnet channel and the core channel. The permanent magnets are secured to the rotor core and are separated by a fixed angle or a fixed distance and the side surfaces of the first permanent magnets are in contact with air, a non-magnetic and non-electrical conducting material, or a second permanent magnet.

Additionally or alternatively, in this or other embodiments the mechanical interface joint includes a dovetail joint.

Additionally or alternatively, in this or other embodiments the core channel and/or the permanent magnet channel has three or more sides.

Additionally or alternatively, in this or other embodiments the core channel cross-section is substantially identical to the permanent magnet channel cross-section.

Additionally or alternatively, in this or other embodiments a circumferential edge of a permanent magnet of the plurality of permanent magnets is skewed relative to a central axis of the rotor.

Additionally or alternatively, in this or other embodiments a magnetic pole of the rotor is defined by two or more magnets of the plurality of permanent magnets.

Additionally or alternatively, in this or other embodiments a second permanent magnet is located between circumferentially adjacent first permanent magnets of the plurality of permanent magnets.

Additionally or alternatively, in this or other embodiments the second permanent magnet is formed from a second magnetic material different from the first magnetic material.

Additionally or alternatively, in this or other embodiments the second permanent magnet has a second magnetization direction different from the first magnetization direction.

Additionally or alternatively, in this or other embodiments the second permanent magnet has a magnetization direction that is in a circumferentially clockwise or counterclockwise direction about a central axis of the rotor.

Additionally or alternatively, in this or other embodiments the second permanent magnet is two or more permanent magnet segments arrayed one or more of axially, radially or circumferentially.

In another embodiment, an electric machine includes a stator, and a rotor located about a rotor axis, defining an air gap between the rotor and the stator, the rotor magnetically interactive with the stator. The rotor includes a rotor core, wherein the rotor core comprises a plurality of axially-stacked rotor laminations, and a plurality of permanent magnets, each of the plurality of permanent magnets having a magnet inner circumferential surface, a magnet outer circumferential surface, and two opposing radial side surfaces. The plurality of permanent magnets are secured at the core outer circumferential surface of the rotor core. The permanent magnets are first permanent magnets made of a first permanent magnet material with a first magnetic orientation. The plurality of permanent magnets are secured to the rotor core via a plurality of mechanical interface joints, the plurality of mechanical interface joints defined by at least one first mechanical interface feature having a permanent magnet channel with a magnet channel surface, located inside the permanent magnet, with the tangent of the magnet channel surface defined by an angle that is between zero and 90 degrees with respect to the magnet inner circumferential surface, at least one second mechanical interface feature having a core channel with a core channel surface located inside of the rotor core, with the tangent of the core channel surface defined by an angle that is between zero and 90 degrees with respect to the core outer circumferential surface. At least one complimentary mechanical interface member is inserted in the magnet channel and the core channel, having surfaces complimentary to the magnet channel and the core channel. The permanent magnets are secured to the rotor core and are separated by a fixed angle or a fixed distance and the side surfaces of the first permanent magnets are in contact with air, a non-magnetic and non-electrical conducting material, or a second permanent magnet.

Additionally or alternatively, in this or other embodiments the mechanical interface joint includes a dovetail joint.

Additionally or alternatively, in this or other embodiments the core channel and/or the permanent magnet channel has three or more sides.

Additionally or alternatively, in this or other embodiments the core channel cross-section is substantially identical to the permanent magnet channel cross-section.

Additionally or alternatively, in this or other embodiments a circumferential edge of a permanent magnet of the plurality of permanent magnets is skewed relative to a central axis of the rotor.

Additionally or alternatively, in this or other embodiments a second permanent magnet located between circumferentially adjacent first permanent magnets of the plurality of permanent magnets.

Additionally or alternatively, in this or other embodiments the second permanent magnet is formed from a second magnetic material different from the first magnetic material.

Additionally or alternatively, in this or other embodiments the second permanent magnet has a second magnetization direction different from the first magnetization direction.

Additionally or alternatively, in this or other embodiments the second permanent magnet has a magnetization direction that is in a circumferentially clockwise or counterclockwise direction about a central axis of the rotor.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is an axial cross-sectional view of an embodiment of an electric machine;

FIG. 2 is an axial cross-sectional view of another embodiment of an electrical machine;

FIG. 3 is a cross-sectional view of a rotor core for an electrical machine;

FIG. 4 illustrates a embodiment of an attachment of a permanent magnet to a rotor core;

FIG. 5 illustrates an embodiment of a permanent magnet attachment to a rotor core via a retaining element;

FIG. 6A illustrates another embodiment of a permanent magnet attachment to a rotor core via a retaining element;

FIG. 6B illustrates yet another embodiment of a permanent magnet attachment to a rotor core via a retaining element;

FIG. 6C illustrates still another embodiment of a permanent magnet attachment to a rotor core via a retaining element;

FIG. 7 illustrates a rotor having circumferentially-skewed permanent magnets; and

FIG. 8 illustrates a rotor having secondary permanent magnets between adjacent primary magnets.

### DETAILED DESCRIPTION

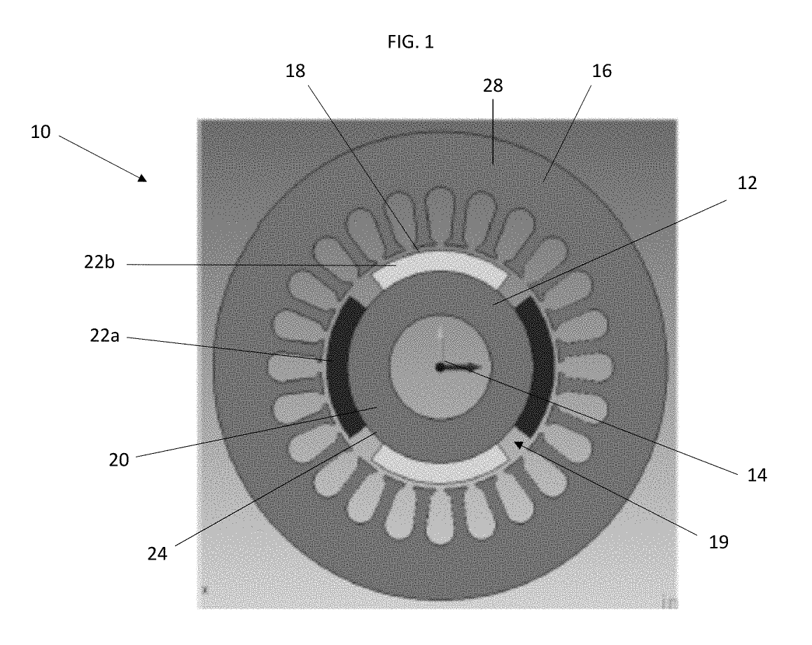

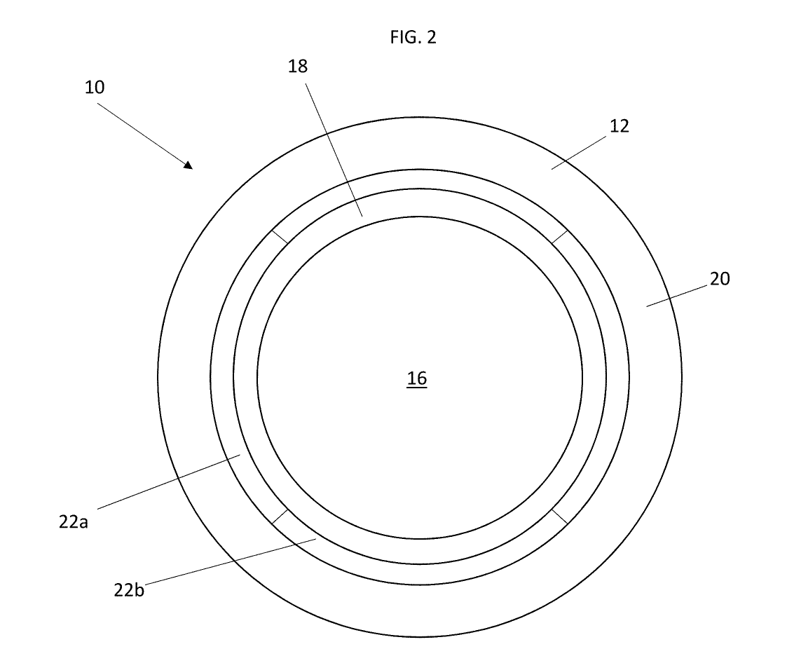

Referring to FIG. 1, an electric machine 10 includes a rotor 12 located at and rotatable about a rotor axis 14. The rotor 12 magnetically interacts with a stator 16 located, in the embodiment of FIG. 1, radially outboard of the rotor 12, and across an airgap 18 between the rotor 12 and the stator 16, to drive rotation of the rotor 12 about the rotor axis 14. While in the embodiment of FIG. 1, the electric machine 10 is configured such that the rotor 12 is located radially inboard of the stator 16, in other embodiments, such as shown in FIG. 2, the rotor 12 may be located radially outboard of the stator 16, while still magnetically interactive with the stator 16 across the airgap 18 between the rotor 12 and the stator 16. One skilled in the art will readily appreciate that the present disclosure may likewise be applied to such configurations.

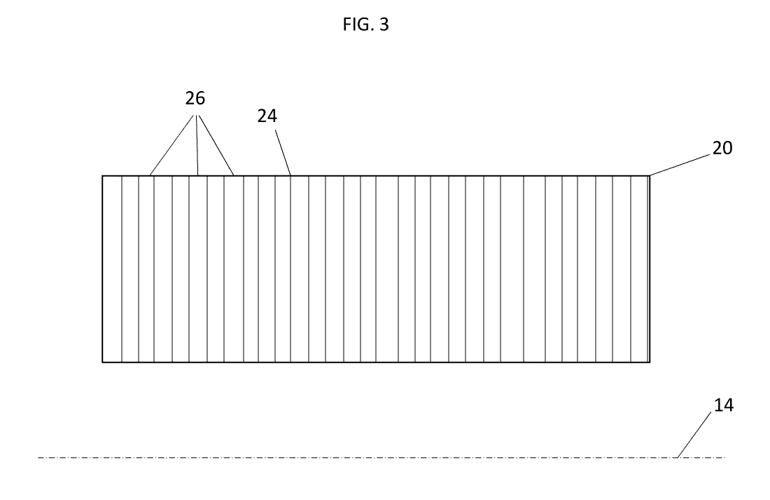

Referring again to FIG. 1, the rotor 12 includes a rotor core 20 and a plurality of permanent magnets 22 located at a core outer circumferential surface 24 of the rotor core 20. In some embodiments, such as shown in FIG. 3, the rotor core 20 is formed from a plurality of axially-stacked rotor laminations 26, while in other embodiments the rotor core 20 may be formed as a unitary element. Referring again to FIG. 1, the stator 16 includes a stator core 28 with one or more conductors (not shown) or windings disposed thereat. During operation, the one or more conductors are energized by an electrical current flowing there through. The current results in a magnetic field, which interacts with the plurality of permanent magnets 22 of the rotor 12 thereby causing rotation of the rotor 12 about the rotor axis 14.

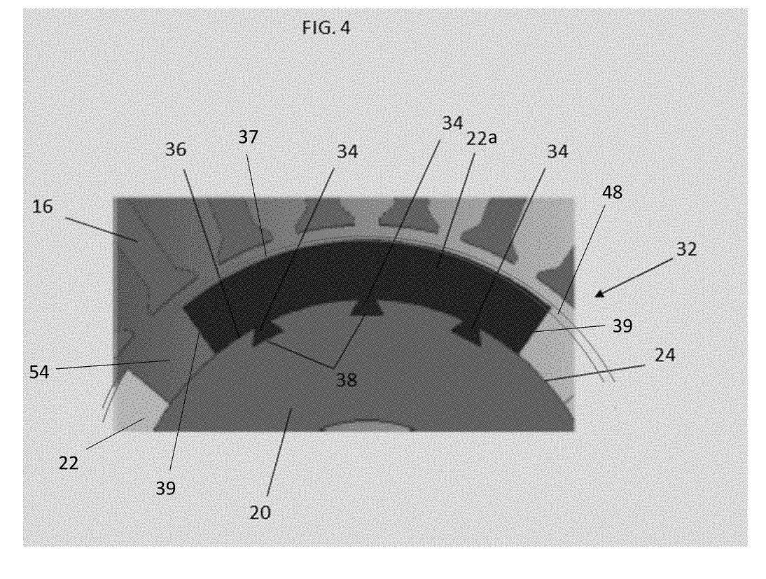

Referring now to FIG. 4, the permanent magnets 22 are circumferential segments including a magnet inner circumferential surface 36, a magnet outer circumferential surface 37 opposite the magnet inner circumferential surface 36, and opposed radial side surfaces 39. The permanent magnets 22 include first permanent magnets 22a formed from a first magnetic material and having a first magnetic orientation and second permanent magnets 22b. In some embodiments, the second permanent magnets 22b may be formed from a second magnetic material different from the first magnetic material and/or may have a second magnetic orientation different from the first magnetic orientation. The radial side surfaces 39 of the first permanent magnets 22a may be circumferentially spaced with a circumferential gap 19 there between such as shown in FIG. 1, or alternatively may abut a second permanent magnet 22b, or may abut a non-magnetic and non-electrically conducting material.

The permanent magnets 22 are secured at the core outer circumferential surface 24 of the rotor core 20 to retain the permanent magnets 22 thereat under centrifugal forces generated by the rotation of the rotor 12 about the rotor axis 14. The permanent magnets 22 are secured via one or more mechanical interfaces between the permanent magnet 22 and the rotor core 20. In some embodiments, the mechanical interface is a dovetail connection 32, in which the permanent magnet 22 includes a magnet dovetail 34 extending radially inwardly from the magnet inner circumferential surface 36 of the permanent magnet 22, while the rotor core 20 includes a complimentary core dovetail 38 extending radially inwardly from the core outer circumferential surface 24 of the rotor core 20. The magnet dovetail 34 and the core dovetail 38 are complimentary such that the magnet dovetail 34 is insertable into the core dovetail 38 to secure the permanent magnet 22 to the rotor core 20. In some embodiments, the magnet dovetail 34 and the core dovetail 38 extend axially along the permanent magnet 22 and the rotor core 20 respectively. In some embodiments, the magnet dovetail 34 may extend continuously along an entire axial extent of the permanent magnet 22, while in other embodiments the magnet dovetail 34 may be segmented along the axial extent. While in FIG. 4 each permanent magnet 22 is illustrated as having three magnet dovetails 34, one skilled in the art will readily appreciate that other quantities of magnet dovetails 34, such as one, two or four magnet dovetails 34 may be used.

In other embodiments, the configuration may be substantially reversed. In such embodiments the magnet dovetails 34 extending radially outwardly from the magnet inner circumferential surface 36 of the permanent magnet 22, while the complimentary core dovetails 38 extending radially outwardly from the core outer circumferential surface 24 of the rotor core 20. While the magnet dovetail 34 and the core dovetail 38 are shown in FIG. 4 as trapezoidal-shaped elements, it is to be appreciated that other shapes, such as oval or circular, or triangular or fir-tree shaped elements may be used.

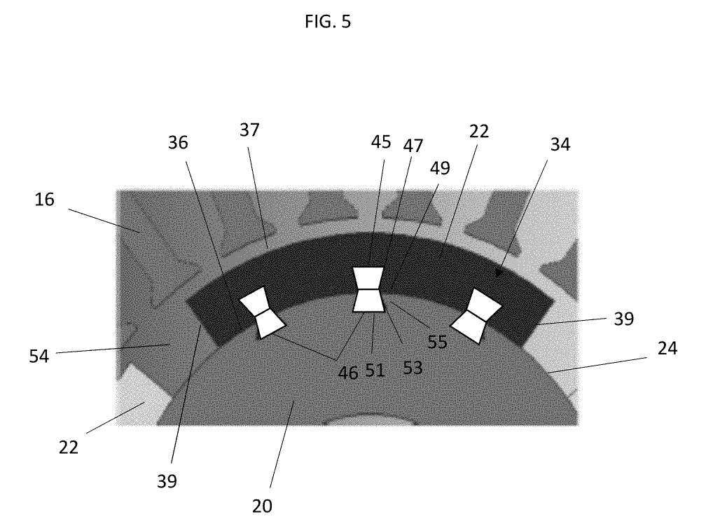

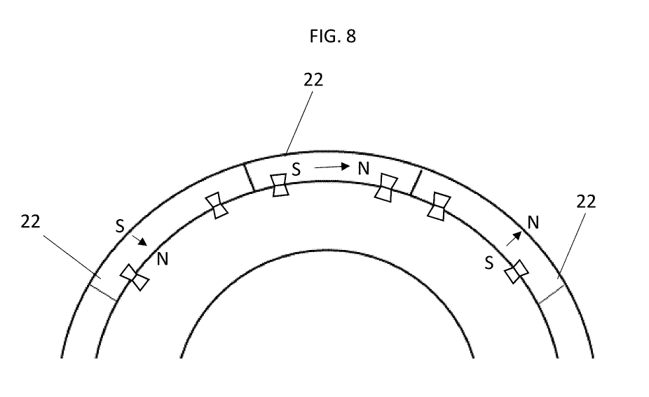

In yet other embodiments, such as shown in FIG. 5, the mechanical interface between the permanent magnets 22 and the rotor core 20 may include one or more mechanical interface members 46, such as a pin element or a bow-tie element to retain the permanent magnets 22 to the rotor core 20. In these embodiments, as best shown in FIG. 8, the magnet dovetail 34 extends into the permanent magnet 22 and includes a magnet channel 45 with a channel surface 47 having an angle 49 to the magnet inner circumferential surface 36 between 0° and 90°. Similarly, the core dovetail 38 extends into the rotor core 20 and includes a core channel 51 with a core channel surface 53 having a core angle 55 to the core outer circumferential surface 24 between 0° and 90°. The mechanical interface member 46 includes member surfaces 57 complimentary to the channel surface 47 and the core channel surface 53 to engage the mechanical interface member 46 with the magnet channel 45 and the core channel 51 when installed thereto.

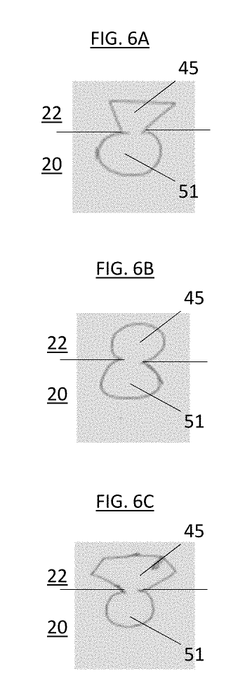

While in the embodiment of FIG. 5, the magnet channel 45 and the core channel 51 are three-sided, it is to be appreciated that in other embodiments other shapes may be utilized, having other numbers of sides and/or including curvilinear shapes. Further, in some embodiments, the magnet channel 45 and the core channel 51 may have substantially identical shapes, while in other embodiments the magnet channel 45 may be differently shaped from the core channel 51. Alternative shapes of magnet channel 45 and core channel 51 combinations, and the corresponding mechanical interface members 46 are illustrated in FIGS. 6A-6C. In FIG. 6A, the core channel 51 is a partial circular configuration, while the magnet channel 45 is three-sided. In the embodiment of FIG. 6B, both the core channel 51 and the magnet channel 45 have a partial circular configuration, and in FIG. 6C the magnet channel 45 has a five-sided configuration while the core channel 51 has a partial circular configuration. It is to be appreciated that the illustrated embodiments are merely exemplary, and that additional configurations are contemplated within the scope of the present disclosure.

The mechanical interface members 46 may be formed from, for example, a metallic or non-metallic material, a composite material, or a same material as the permanent magnet 22 depending on required mechanical properties and performance characteristics. Such mechanical interface members 46 may be unitary or segmented in, for example, a radial, axial and/or circumferential direction. Further, in some embodiments, such as shown in FIG. 4, the rotor 12 includes a retaining sleeve 48 located about the rotor outer radius. In some embodiments, the retaining sleeve 48 extends along an entire axial length of the rotor 12, while in other embodiments the retaining sleeve 48 extends only partially along the axial length. Further, a plurality of retaining sleeves 48 may be arranged along the axial length. The retaining sleeves may axially abut one another, or alternatively may define sleeve gaps therebetween. The retaining sleeve 48 may be made of, for example, carbon fiber, Inconel, metal, or any high strength, low electric conductive alloy. The retaining sleeve 46 is secured to the rotor 12 by, for example, an adhesive, by shrink-fit or any other suitable attachment means. Further, an adhesive, filled or unfilled, may be included to aid in retention of the permanent magnets 22 at the rotor core 20.

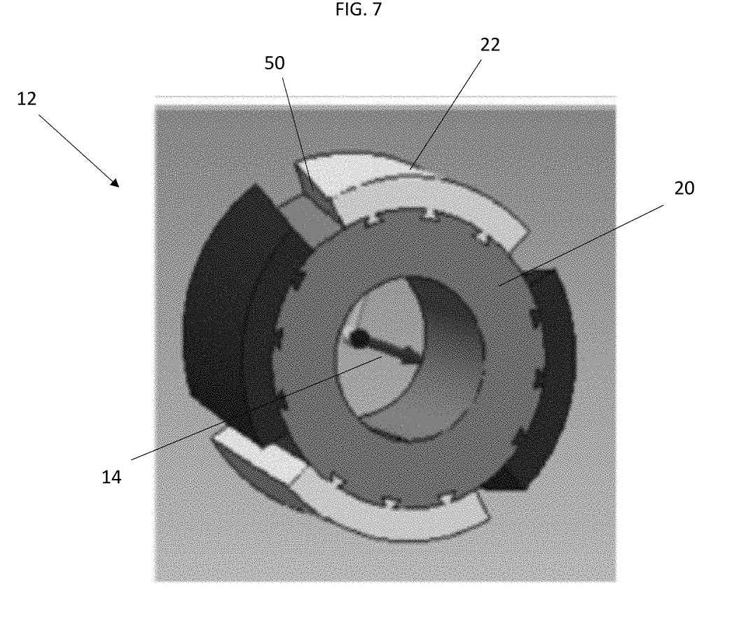

In some embodiments, the permanent magnets 22 extend substantially axially along the rotor core 20, while in other embodiments as shown in FIG. 7, circumferential ends 50 of the permanent magnets 22 are skewed or nonparallel to the rotor axis 14. Further, some rotors 12 are a four-pole configuration, while in other embodiments other even numbers of poles may be present. In some embodiments, such as those illustrated, each pole is defined by a single permanent magnet 22, while in other embodiments, two or more permanent magnet circumferential segments may be utilized to define each magnetic pole, the two or more permanent magnet 22 segments are arranged or stacked, for example, radially, circumferentially and/or axially. The size and shape of the magnet segments may be varied depending on performance requirement and/or magnetic flux density in the airgap 18.

In some embodiments, such as shown in FIG. 4, a circumferential gap 54 is present between circumferentially adjacent permanent magnets 22, while in other embodiments such as shown in FIG. 8, additional secondary magnets 22 having different magnetic orientations are placed between circumferentially adjacent primary magnets 22. The secondary magnets 22 may be similarly retained to the rotor core 20. In FIG. 8, the mechanical interface members 46 are omitted for clarity.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate in spirit and/or scope. Additionally, while various embodiments have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A rotor of an electric machine, comprising:
a rotor core, wherein the rotor core comprises a plurality of axially-stacked rotor laminations; and
a plurality of permanent magnets, each of the plurality of permanent magnets having a magnet inner circumferential surface, a magnet outer circumferential surface, and two opposing radial side surfaces, the plurality of permanent magnets secured at the core outer circumferential surface of the rotor core, the permanent magnets are first permanent magnets made of a first permanent magnet material with a first magnetic orientation;
wherein the plurality of permanent magnets are secured to the rotor core via a plurality of mechanical interface joints, the plurality of mechanical interface joints defined by:
at least one first mechanical interface feature having a permanent magnet channel with a magnet channel surface, disposed inside the permanent magnet, with the tangent of the magnet channel surface defined by an angle that is between zero and 90 degrees with respect to the magnet inner circumferential surface;
at least one second mechanical interface feature having a core channel with a core channel surface disposed inside of the rotor core, with the tangent of the core channel surface defined by an angle that is between zero and 90 degrees with respect to the core outer circumferential surface; and
at least one complimentary mechanical interface member inserted in the magnet channel and the core channel, having surfaces complimentary to the magnet channel and the core channel;
wherein the permanent magnets secured to the rotor core are separated by a fixed angle or a fixed distance; and
wherein the side surfaces of the first permanent magnets are in contact with air, a non-magnetic and non-electrical conducting material, or a second permanent magnet.

2. The rotor of claim 1, wherein the mechanical interface joint comprises a dovetail joint.

3. The rotor of claim 1, wherein the core channel and/or the permanent magnet channel has three or more sides.

4. The rotor of claim 1, wherein the core channel cross-section is substantially identical to the permanent magnet channel cross-section.

5. The rotor of claim 1, wherein a circumferential edge of a permanent magnet of the plurality of permanent magnets is skewed relative to a central axis of the rotor.

6. The rotor of claim 1, a magnetic pole of the rotor is defined by two or more magnets of the plurality of permanent magnets.

7. The rotor of claim 1, including a second permanent magnet disposed between circumferentially adjacent first permanent magnets of the plurality of permanent magnets.

8. The rotor of claim 7, wherein the second permanent magnet is formed from a second magnetic material different from the first magnetic material.

9. The rotor of claim 7, wherein the second permanent magnet has a second magnetization direction different from the first magnetization direction.

10. The rotor of claim 7, wherein the second permanent magnet has a magnetization direction that is in a circumferentially clockwise or counterclockwise direction about a central axis of the rotor.

11. The rotor of claim 7, wherein the second permanent magnet is two or more permanent magnet segments arrayed one or more of axially, radially or circumferentially.

12. An electric machine comprising:
a stator;
a rotor located about a rotor axis, defining an air gap between the rotor and the stator, the rotor magnetically interactive with the stator and including:
a rotor core, wherein the rotor core comprises a plurality of axially-stacked rotor laminations; and
a plurality of permanent magnets, each of the plurality of permanent magnets having a magnet inner circumferential surface, a magnet outer circumferential surface, and two opposing radial side surfaces, the plurality of permanent magnets secured at the core outer circumferential surface of the rotor core, the permanent magnets are first permanent magnets made of a first permanent magnet material with a first magnetic orientation;
wherein the plurality of permanent magnets are secured to the rotor core via a plurality of mechanical interface joints, the plurality of mechanical interface joints defined by:
at least one first mechanical interface feature having a permanent magnet channel with a magnet channel surface, disposed inside the permanent magnet, with the tangent of the magnet channel surface defined by an angle that is between zero and 90 degrees with respect to the magnet inner circumferential surface;
at least one second mechanical interface feature having a core channel with a core channel surface disposed inside of the rotor core, with the tangent of the core channel surface defined by an angle that is between zero and 90 degrees with respect to the core outer circumferential surface; and
at least one complimentary mechanical interface member inserted in the magnet channel and the core channel, having surfaces complimentary to the magnet channel and the core channel;
wherein the permanent magnets secured to the rotor core are separated by a fixed angle or a fixed distance; and
wherein the side surfaces of the first permanent magnets are in contact with air, a non-magnetic and non-electrical conducting material, or a second permanent magnet.

13. The electrical machine of claim 12, wherein the mechanical interface joint comprises a dovetail joint.

14. The electrical machine of claim 12, wherein the core channel and/or the permanent magnet channel has three or more sides.

15. The electrical machine of claim 12, wherein the core channel cross-section is substantially identical to the permanent magnet channel cross-section.

16. The electrical machine of claim 12, wherein a circumferential edge of a permanent magnet of the plurality of permanent magnets is skewed relative to a central axis of the rotor.

17. The electrical machine of claim 12, including a second permanent magnet disposed between circumferentially adjacent first permanent magnets of the plurality of permanent magnets.

18. The electrical machine of claim 17, wherein the second permanent magnet is formed from a second magnetic material different from the first magnetic material.

19. The electrical machine of claim 17, wherein the second permanent magnet has a second magnetization direction different from the first magnetization direction.

20. The electrical machine of claim 17, wherein the second permanent magnet has a magnetization direction that is in a circumferentially clockwise or counterclockwise direction about a central axis of the rotor.
